(19) United States
(12) Patent Application Publication
(10) Pub. No.: US 2022/0198906 A1
(43) Pub. Date: Jun. 23, 2022

(54) Social Distancing System

(71) Applicant: Jean Ava Pollard, Port Arthur, TX (US)

(72) Inventor: Jean Ava Pollard, Port Arthur, TX (US)

(21) Appl. No.: 17/167,216

(22) Filed: Feb. 4, 2021

Related U.S. Application Data
(60) Provisional application No. 63/129,908, filed on Dec. 23, 2020.

(51) Int. Cl. G08B 21/18; H04W 4/02; G08B 7/06

(52) U.S. Cl. CPC G08B 21/182; G08B 7/06; H04W 4/023

(57) ABSTRACT

The invention relates to a social distancing device and method of use. The social distancing device comprises a proximity sensing component and an alerting component. The proximity sensing component comprises an adjusting element for selecting a proximity distance from another person. The alerting component may comprise an audible alert element, a visual alert element, a vibrational alert element, or a combination thereof. The alerting component is configured to provide an alert when triggered by the proximity sensing component so that a user knows that they are no longer social distancing. The system uses a plurality of social distancing devices in conjunction with a mobile application that is connected to a server via a network. The server is configured to receive proximity distances from the plurality of social distancing devices and communicate alerts when proper social distancing is not occurring.

### CROSS-REFERENCE TO RELATED APPLICATION

The present application claims priority to, and the benefit of, U.S. Provisional Application No. 63/129,908, which was filed on Dec. 23, 2020 and is incorporated herein by reference in its entirety.

### BACKGROUND

The present invention generally relates to a way for people at risk for infection to maintain safe and proper social distancing, and more specifically to a social distancing detector that can alert a user when they are in danger of an unwanted inhaled respiratory threat. Accordingly, the present specification makes specific reference thereto. However, it is to be appreciated that aspects of the present invention are also equally amenable to other like applications, devices and methods of manufacture.

Germs, viruses, bacteria, and other pathogens are tiny living things found everywhere in nature that are too small to be seen by the naked eye. These organisms are extremely dangerous to inhale and can lead to serious illness. Viruses are a significant cause of infectious diseases acquired in indoor environments causing considerable impact on human health. COVID-19 is one example of an extremely infectious respiratory virus caused by a coronavirus called SARS-CoV-2 that is transmissible directly from person to person. Other respiratory viruses include the flu and the common cold. Such viruses are spread mainly through respiratory droplets that are produced when an infected person coughs or sneezes. These respiratory droplets are easily inhaled by people who are nearby increasing disease transmission. Close contact between people greatly increases the likelihood of exposure from an infected person.

One way of protecting people from these inhaled viruses is through the use of physical barriers including protective face coverings, such as face masks. There are many different types of masks with varying levels of effectiveness. Face masks are beneficial as they can protect the wearer from exposure to air born transmission of disease. Face masks used by an infected individual protect others as the masks collect and contain much of the exhaled and expelled airborne respiratory droplets from the infected person. To be truly effective, a large percentage of people must all wear masks simultaneously and properly to be somewhat effective at reducing disease transmission. Mask wearing compliance has unfortunately been politicized and has become a challenge with many people outright refusing to wear any kind of face covering leaving many individuals desiring protection at risk from unwanted infection.

Even with masks, health organizations almost uniformly recommend social distancing be incorporated with any protective measures. Social distancing is the public health practice of encouraging people to keep their physical distance from each other during disease outbreaks in order to slow the spread of infection. The purpose of social distancing is to reduce the spread of infectious diseases and to lessen the impact on society and especially on the medical care system. During a pandemic or other viral outbreak, social distancing of six feet or more between people is incredibly important to curb the spread of disease. People are often unaware of how far six feet actually is and accidently end up too close to each other. Without some kind of distance indicating tool, people will inadvertently be put at and put others at unnecessary risk of disease.

Accordingly, there is a long felt need in the art for an improved way for people to maintain appropriate and effective social distancing. In this manner, the improved social distancing system of the present invention accomplishes all of the forgoing objectives, thereby providing an easy way for people to remain safe from respiratory transmitted diseases. A primary feature of the present invention is a device that alerts users when they are too close to each other and not practicing proper social distancing. The present invention is capable of improving safety by reducing the spread of germs, bacteria, and viruses during a pandemic or disease season by ensuring that people properly distance themselves from others.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a social distancing device for allowing a user to maintain a proper social distance from others. The social distancing device comprises a proximity sensing component and an alerting component retained within a housing. The housing is manufactured from a durable plastic and may be weather resistant. The social distancing device may further comprise an attachment component. The attachment component may be a clip, bracket, strap, or similar attachment mechanism to allow a user to wear or carry the social distancing device on their person. The social distancing device further comprises a mobile power source. The mobile power source is enclosed within the housing and may be rechargeable.

The proximity sensing component is configured to determine a distance between the social distancing device and another person. The proximity sensing component comprises an adjustment element. The adjustment element may be a dial or switch that allows the user to select a proximity distance. The proximity distance selectable may vary depending on the distance that the user wishes to use. The selectable proximity distance is typically twelve feet or less, with a six foot distance commonly selected.

The alerting component is in electronic communication with and triggerable by the proximity sensing component. The alerting component is configured to warn the user when the predetermined distance is breached by another person. The alerting component comprises an audible alert element. The audible alert element is configured to sound an audible warning when the predetermined distance is breached. The alerting component further comprises a vibrational alert element. The vibrational alert element is configured to provide a vibration warning when the predetermined distance is breached. The alerting component further comprises a visual alert element. The visual alert element is configured to provide a visual warning when the predetermined distance is breached.

The subject matter disclosed and claimed herein, in another embodiment thereof, comprises a social distancing system for allowing users to properly social distance. The social distancing system comprises a plurality of social distancing devices. Each social distancing device comprises a proximity sensing component and an alerting component retained within a housing. The housing is manufactured from a durable plastic and may be weather resistant. The social distancing device may further comprise an attachment component. The attachment component may be a clip, bracket, strap, or similar attachment mechanism to allow a user to wear or carry the social distancing device on their person. The social distancing device further comprises a mobile power source. The mobile power source is enclosed within the housing and may be rechargeable.

The proximity sensing component is configured to determine a distance between the social distancing device and another person. The proximity sensing component comprises an adjustment element. The adjustment element may be a dial or switch that allows the user to select a proximity distance. The proximity distance selectable may vary depending on the distance that the user wishes to use. The selectable proximity distance is typically ten feet or less, with a six foot distance commonly selected.

The alerting component is in electronic communication with and triggerable by the proximity sensing component. The alerting component is configured to warn the user when the predetermined distance is breached by another person. The alerting component comprises an audible alert element. The audible alert element is configured to sound an audible warning when the predetermined distance is breached. The alerting component further comprises a vibrational alert element. The vibrational alert element is configured to provide a vibration warning when the predetermined distance is breached. The alerting component further comprises a visual alert element. The visual alert element is configured to provide a visual warning when the predetermined distance is breached.

The social distancing system further comprises a plurality of personal interface devices. The personal interface devices are typically mobile electronic devices such as a smart phone. Each personal interface device is in electronic communication with one of the social distancing devices. The social distancing system further comprises a mobile application storable on each of the personal interface devices. The social distancing system further comprises a network and a remote server. The mobile application comprises a set of computer readable software instructions. When executed by a processor of each personal interface device, the mobile application accesses the remote server. The remote server comprises a database and a memory. When accessed, the database is configured to identify when any of the plurality of social distancing devices are within a selected predetermined distance of each other. Once identified, a communications module of the remote server is configured to communicate a notification to the affected social distancing devices so that the affected social distancing devices can alert the users that the predetermined distance has been breached.

The subject matter disclosed and claimed herein, in another embodiment thereof, comprises a method of maintaining social distancing. The method comprises activating a social distancing device. The social distancing device comprises a proximity sensing component and an alerting component retained within a housing. The proximity sensing component is configured to determine a distance between the social distancing device and another person. The proximity sensing component comprises an adjustment element. The adjustment element may be a dial or switch that allows the user to select a proximity distance. The proximity distance selectable may vary depending on the distance that the user wishes to use. The selectable proximity distance is typically ten feet or less, with a six foot distance commonly selected.

The alerting component is in electronic communication with and triggerable by the proximity sensing component. The alerting component is configured to warn the user when the predetermined distance is breached by another person. The alerting component comprises an audible alert element. The audible alert element is configured to sound an audible warning when the predetermined distance is breached. The alerting component further comprises a vibrational alert element. The vibrational alert element is configured to provide a vibration warning when the predetermined distance is breached. The alerting component further comprises a visual alert element. The visual alert element is configured to provide a visual warning when the predetermined distance is breached.

The method continues by sending a signal up to a predetermined distance from the social distancing device. If someone or another social distancing device is within the predetermined distance, a feedback is received to the social distancing device that someone is within the predetermined distance. Alternatively, the social distancing device may receive a signal from a second social distancing device that the predetermined distance has been breached. In either event, the social distancing device then alerts the user that someone is within the predetermined distance, and the person may move to a safe distance.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of a social distancing device of the present invention in accordance with the disclosed architecture.

FIG. 2 illustrates a rear perspective view of the social distancing device of the present invention in accordance with the disclosed architecture.

FIG. 3 illustrates an overhead rear perspective view of the social distancing device of the present invention in accordance with the disclosed architecture.

FIG. 4 illustrates a perspective view of a user wearing the social distancing device of the present invention in accordance with the disclosed architecture.

FIG. 5 illustrates a perspective view of the social distancing device of the present invention alerting a user when a predetermined distance between the user and another person is breached in accordance with the disclosed architecture.

FIG. 6 illustrates a schematic view of one embodiment of a social distancing system of the present invention comprising a plurality of social distancing devices in accordance with the disclosed architecture.

FIG. 7 illustrates a method of one embodiment of maintaining social distancing using a social distancing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is an attachable social distancing device capable of notifying the wearer and others when they are too close together and not practicing proper social distancing. The device includes a vibration function and an audible alert that warns users when social distancing parameters are not being met. The device alerts users when another individual is less than six feet away so that they have an opportunity to increase the distance between them. The device offers a simple and easy method of identifying the proper distance between people.

The social distancing device comprises an electronic sensor that is attachable to a user vis a clip-on, snap-on, or other type of attachment. The device may have a plastic housing and may be integrated into the design of jewelry, headbands, clothing, purses, backpacks, and other wearable accessories. The device is configured to determine a six foot distance between two or more people via proximity sensors. Users can adjust the preferred separation distance using a dial to select distance. A button or other user input allows the user to select vibration or audible alerts when the set parameters are breached. A mobile application may be used to control the device. An accompanying face mask may be used in conjunction with the device for more complete protection.

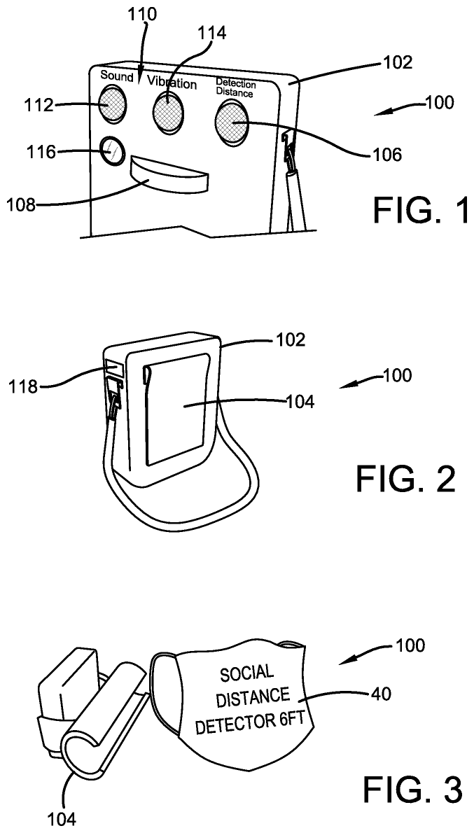

Referring initially to the drawings, FIGS. 1-5 illustrate a social distancing device 100 for allowing a user to properly social distance. Social distancing, also called “physical distancing,” means keeping a safe space between yourself and other people. To practice social or physical distancing, a typical recommendation is to stay at least six feet from other people in both indoor and outdoor spaces. However, this distance is arbitrary depending on the circumstance and may be further or closer as desired.

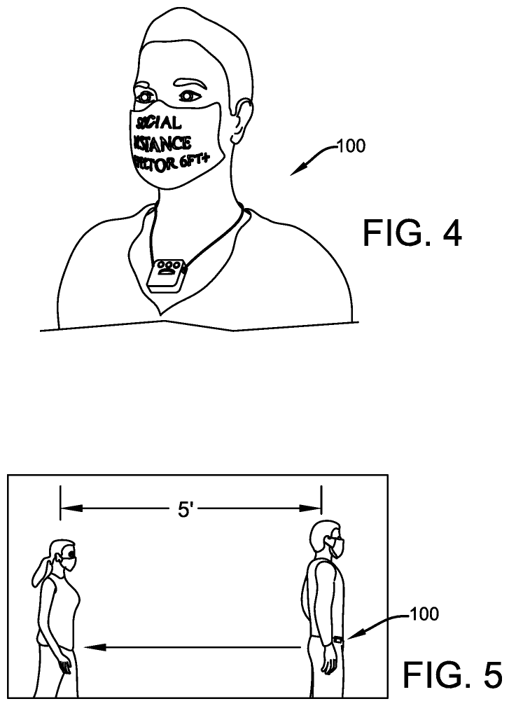

The social distancing device 100 comprises a proximity sensing component 106 and an alerting component 110 retained within a housing 102. The housing 102 is manufactured from a durable plastic and may be weather resistant. The social distancing device 100 may further comprise an attachment component 104 as illustrated in FIGS. 2 and 3. The attachment component 104 may be a clip, bracket, strap, or similar attachment mechanism to allow a user to wear or carry the social distancing device 100 on their person as illustrated in FIG. 4. The attachment component 104 may be integrated into the housing 104 or may be completely detachable from the housing 102. The social distancing device 100 further comprises a mobile power source 118. The mobile power source 118 is a battery that is enclosed within the housing 102 and may be rechargeable.

As illustrated in FIGS. 1 and 5, the proximity sensing component 106 is configured to determine a distance between the social distancing device 100 and another person. The proximity sensing component 106 may be configured to detect motion. The proximity sensing component 106 comprises an adjustment element 108. The adjustment element 106 may be a dial or switch that allows the user to select a proximity distance to another person. The proximity distance selectable may vary depending on the distance that the user wishes to use. The selectable proximity distance is typically twelve feet or less, with a six foot distance commonly selected.

The alerting component 110 is in electronic communication with and triggerable by the proximity sensing component 106. The alerting component 110 is configured to warn the user when the predetermined distance is breached by another person. The alerting component 110 comprises an audible alert element 112. The audible alert element 112 is configured to sound an audible warning when the predetermined distance is breached. The audible alert may be a sound or voice instructions. The alerting component 110 further comprises a vibrational alert element 114. The vibrational alert element 114 is configured to provide a vibration warning when the predetermined distance is breached. The alerting component 110 further comprises a visual alert element 116. The visual alert element 116 is configured to provide a visual warning when the predetermined distance is breached. The visual alert element 116 may be a light or lamp configured to illuminate continuously or in a pattern and may use different colors to warn the user. As illustrated in FIG. 4, a face mask 40 may also be used in conjunction with the social distancing device 100 to help protect and remind the user that proper social distancing is needed.

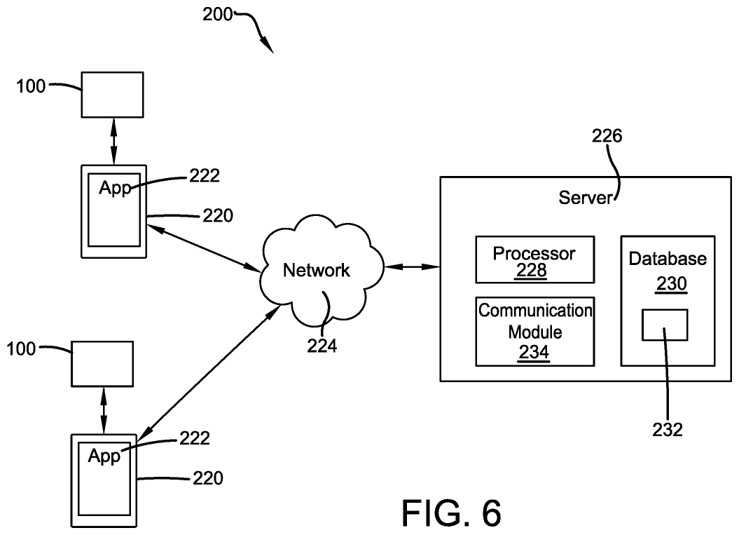

As illustrated in FIG. 6, the subject matter disclosed and claimed herein, in another embodiment thereof, comprises a social distancing system 200 for allowing users to properly social distance. The social distancing system 200 comprises a plurality of social distancing devices 100. Each social distancing device 100 comprises a proximity sensing component 106 and an alerting component 110 retained within a housing 102 as discussed supra. Each social distancing device 100 may further comprise an attachment component 104. The attachment component 104 may be a clip, bracket, strap, or similar attachment mechanism to allow a user to wear or carry the social distancing device 100 on their person. The attachment component 104 may be integrated into the housing 104 or may be completely detachable from the housing 102. The social distancing device 100 further comprises a mobile power source 118. The mobile power source 118 is a battery that is enclosed within the housing 102 and may be rechargeable.

Each proximity sensing component 106 is configured to determine a distance between the social distancing device 100 and another person or another social distancing device 100. The proximity sensing component 106 may be configured to detect motion. The proximity sensing component 106 comprises an adjustment element 108. The adjustment element 106 may be a dial or switch that allows the user to select a proximity distance to another person or another social distancing device 100. The proximity distance selectable may vary depending on the distance that the user wishes to use. The selectable proximity distance is typically approximately six feet, although it may be further or closer as desired.

Each alerting component 110 is in electronic communication with and triggerable by the proximity sensing component 106. The alerting component 110 is configured to warn the user when the predetermined distance is breached by another person or another social distancing device 100. The alerting component 110 comprises an audible alert element 112. The audible alert element 112 is configured to sound an audible warning when the predetermined distance is breached. The audible alert may be a sound or voice instructions. The alerting component 110 further comprises a vibrational alert element 114. The vibrational alert element 114 is configured to provide a vibration warning when the predetermined distance is breached. The alerting component 110 further comprises a visual alert element 116. The visual alert element 116 is configured to provide a visual warning when the predetermined distance is breached. The visual alert element 116 may be a light or lamp configured to illuminate continuously or in a pattern and may use different colors to warn the user.

The social distancing system 200 further comprises a plurality of personal interface devices 220. The personal interface devices 220 are typically mobile electronic devices such as a smart phone. Each personal interface device 220 is in electronic communication with one of the social distancing devices 100. The social distancing system 200 further comprises a mobile application 222. The mobile application 222 is up loadable to and storable on each of the personal interface devices 220. The social distancing system 200 further comprises a network 224 and a remote server 226.

The network 224 may be any of a number of private or public communications mechanisms such as the Internet, a local intranet, a Personal Area Network, a Local Area Network, a Wide Area Network, a Virtual Private Network, or the like. When one of the personal interface devices 220 is connected to the remote server 226 via the network 224, the mobile application 222 allows the server 226 to perform methods of the present technology when executed by a server processor 228.

The mobile application 222 comprises a set of computer readable software instructions. When executed by a processor of each personal interface device 220, the mobile application 222 accesses the remote server 226. The remote server 226 comprises a database 230 and a memory 232 triggered by the server processor 228. When accessed by the mobile application 222, the database 230 is configured to identify when any of the plurality of social distancing devices 100 are within a selected predetermined distance of each other. Once identified, a communications module 234 of the remote server 236 is configured to communicate a notification to any affected social distancing devices 100 so that the affected social distancing devices 100 can alert the users that the predetermined distance has been breached.

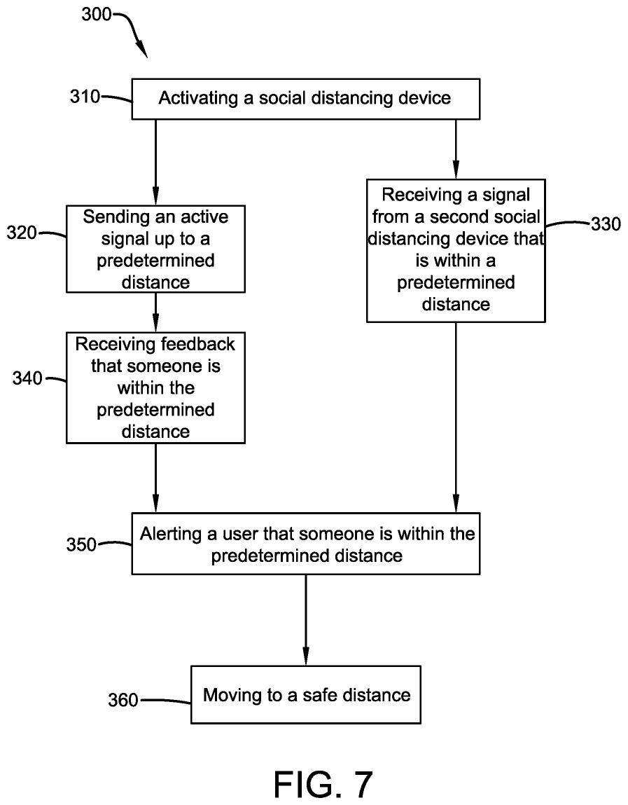

As illustrated in FIG. 7, the subject matter disclosed and claimed herein, in another embodiment thereof, comprises a method 300 of maintaining social distancing. The method 300 begins by activating a social distancing device 100. Each social distancing device 100 comprises a proximity sensing component 106 and an alerting component 110 retained within a housing 102 as discussed supra. Each social distancing device 100 may further comprise an attachment component 104. The attachment component 104 may be a clip, bracket, strap, or similar attachment mechanism to allow a user to wear or carry the social distancing device 100 on their person. The attachment component 104 may be integrated into the housing 104 or may be completely detachable from the housing 102. The social distancing device 100 further comprises a mobile power source 118. The mobile power source 118 is a battery that is enclosed within the housing 102 and may be rechargeable.

Each proximity sensing component 106 is configured to determine a distance between the social distancing device 100 and another person or another social distancing device 100. The proximity sensing component 106 comprises an adjustment element 108. The adjustment element 106 may be a dial or switch that allows the user to select a proximity distance to another person or another social distancing device 100. The proximity distance selectable may vary depending on the distance that the user wishes to use. The selectable proximity distance is typically approximately six feet, although it may be further or closer as desired.

Each alerting component 110 is in electronic communication with and triggerable by the proximity sensing component 106. The alerting component 110 is configured to warn the user when the predetermined distance is breached by another person or another social distancing device 100. The alerting component 110 comprises an audible alert element 112. The audible alert element 112 is configured to sound an audible warning when the predetermined distance is breached. The audible alert may be a sound or voice instructions. The alerting component 110 further comprises a vibrational alert element 114. The vibrational alert element 114 is configured to provide a vibration warning when the predetermined distance is breached. The alerting component 110 further comprises a visual alert element 116. The visual alert element 116 is configured to provide a visual warning when the predetermined distance is breached. The visual alert element 116 may be a light or lamp configured to illuminate continuously or in a pattern and may use different colors to warn the user.

The method 300 continues by sending a signal up to a predetermined distance from the social distancing device 100 at 320. If someone or another social distancing device 100 is within the predetermined distance, at 340 a feedback is received to the social distancing device 100 that someone is within the predetermined distance. Alternatively, at 320 the social distancing device 100 may receive a signal from a second social distancing device 100 that the predetermined distance has been breached. In either event, at 350 the social distancing device 100 then alerts the user that someone is within the predetermined distance, and at 360 the person may move to a safe distance.

Notwithstanding the forgoing, the social distancing device 100 can by any suitable size, shape, and configuration as is known in the art without affecting the overall concept of the invention, provided that it accomplishes the above stated objectives. One of ordinary skill in the art will appreciate that the shape and size of the social distancing device 100 and its various components, as show in the FIGS. are for illustrative purposes only, and that many other shapes and sizes of the social distancing device 100 are well within the scope of the present disclosure. Although dimensions of the device 100 and its components (i.e., length, width, and height) are important design parameters for good performance, the social distancing device 100 and its various components may be any shape or size that ensures optimal performance during use and/or that suits user need and/or preference. As such, the social distancing device 100 may be comprised of sizing/shaping that is appropriate and specific in regard to whatever the social distancing device 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A social distancing device comprising:
a proximity sensing component comprising an adjustment element for selecting a proximity distance;
an alerting component configured to provide an alert when triggered by the proximity sensing component; and
a mobile power source.

2. The social distancing device of claim 1 further comprising an attachment component for engaging a user.

3. The social distancing device of claim 1, wherein the selectable proximity distance is twelve feet or less.

4. The social distancing device of claim 1, wherein the alerting component comprises an audible alert element.

5. The social distancing device of claim 1, wherein the alerting component comprises a vibrational alert element.

6. The social distancing device of claim 1, wherein the alerting component comprises a visual alert element.

7. The social distancing device of claim 6, wherein the visual alert element is a light.

8. A social distancing system comprising:
a plurality of social distancing devices;
a plurality of personal interface devices, each personal interface device in communication with one of the social distancing devices;
a mobile application comprising a set of computer readable software instructions stored on each personal interface device, that when executed by a processor of each personal interface device access a remote database configured to identify and provide notification when any of the plurality of social distancing devices are within a predetermined distance of each other.

9. The social distancing system of claim 8, wherein each social distancing device comprises a proximity sensing component comprising an adjustment element for selecting a proximity distance; and an alerting component configured to provide an alert when triggered by the proximity sensing component.

10. The social distancing system of claim 9, wherein each proximity sensing component is configured to detect motion.

11. The social distancing system of claim 8, wherein each social distancing device comprises an attachment component for engaging a user.

12. The social distancing system of claim 8, wherein each social distancing device is rechargeable.

13. The social distancing system of claim 8, wherein the predetermined distance is six feet or less.

14. The social distancing system of claim 8, wherein each social distancing device is configured to provide an audible alert.

15. The social distancing system of claim 8, wherein each social distancing device is configured to provide a vibrational alert.

16. The social distancing system of claim 8, wherein each social distancing device is configured to provide a visual alert.

17. A method of maintaining social distancing comprising the steps of:
activating a social distancing device;
sending a signal up to a predetermined distance from the social distancing device;
receiving a feedback that someone is within the predetermined distance; and
alerting a user that someone is within the predetermined distance.

18. The method of claim 17, wherein the social distancing device comprises a proximity sensing component comprising an adjustment element for selecting a proximity distance; and
an alerting component configured to provide an alert when triggered by the proximity sensing component.

19. The method of claim 18, wherein the alert is audible, vibrational, or visual.

20. The method of claim 17 further comprising the step of receiving a signal from a second social distancing device that is within the predetermined distance.
